(19) United States
(12) Patent Application Publication
(10) Pub. No.: US 2023/0240339 A1
(43) Pub. Date: Aug. 3, 2023

(54) MCR- Microbial Cleansing Refrigerator

(71) Applicant: Myles Egbowon, Naperville, IL (US)

(72) Inventor: Myles Egbowon, Napervile, IL (US)

(21) Appl. No.: 17/588,678

(22) Filed: Jan. 31, 2022

(51) Int. Cl. A23L 3/30; F25D 29/00

(52) U.S. Cl. CPC A23L 3/30; F25D 29/00

(57) ABSTRACT

Using ultrasound to preserve the freshness and quality of bread, fruits, vegetables, and even meats is the objective of the device. Killing 99.99% of all bacteria & micro organisms within the sonic range of the ultrasound, this device preserves food without the need for harmful chemicals or preservatives/or keeps food fresher longer, removing the ability for food to spoil entirely. The utility is the use of a piezoelectricity system in the form of a produce mat that lays on shelves and preserves food for a long period of time. Using thirty second bursts of high powered ultrasound, we can remove bacteria from a given area in that timeframe, each hour, per day. This allows for high power utility, and low exposure to ultrasound, prolonging the lifespan of perishable foods placed on the mat. This is specifically designed to integrate as a component for a refrigerator. Installed on the floor of the refrigerator. Sound travels better and longer in cold environments, so this technology is synergistic with the refrigerator it will be installed in.

### FIELD OF INVENTION

The technology relates to the general field of food preservation, and has certain specific applications to refrigeration.

### BACKGROUND

In recent years, the number of households that bulk purchase, make up, and stock foods is increasing, and it is necessary to increase the preservation time of household refrigerators. On the other hand, there is a high interest in the deliciousness of food, and there is a need for a preservation function that can maintain the food in high quality.

### SUMMARY

The present invention seeks to provide a solution to food preservation by eliminating all microbes on any food item, using a food preservation device that contains an timed burst of ultrasonic soundwaves, generated from piezoelectric crystals, encapsulated by a sound reflection device to bounce soundwaves in a contained environment, controlled by a computerized system. This food preservation system takes place in a refrigerator, but is not limited in exterior application

### BRIEF DESCRIPTION OF THE DRAWINGS

FIG. 1 illustrates an ultrasonic refrigerator & its functions.

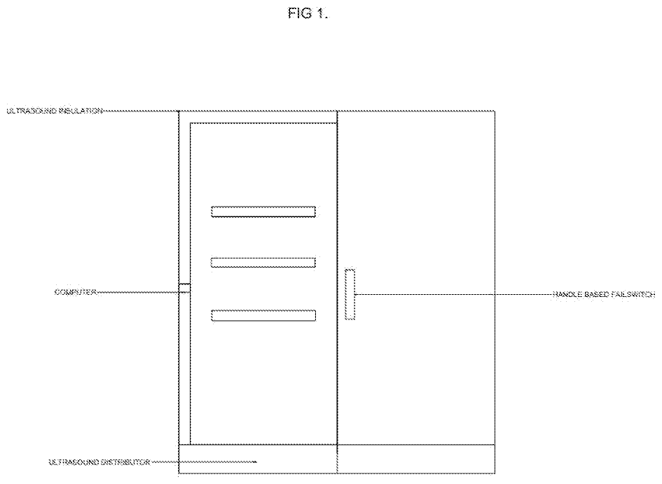

### DETAILED DESCRIPTION AND PREFERRED EMBODIMENT

The invention eliminates all microbial cultures in a contained refrigerator, prolonging the life of the food, but not limited to refrigerators as it can be used as a standalone device. This invention uses piezoelectric crystals to distribute ultrasonic waves to eliminate bacteria in food.

### Definitions

Ultrasound Distributor: This piezoelectric crystal can produce the ultrasounds needed to kill bacteria. When electricity is applied to the piezoelectric crystal, it vibrates and generates ultrasound. It can be made of any piezoelectric crystal available in the market. This ultrasound distributor is underneath the refrigerator plastic, at the bottom of the refrigerator. Sound is distributed directly up into the food. The distributor's purpose is to distribute ultrasound directly into the food it is targeting. The device is a formlessly shaped system, depending on the size and shape of a specific refrigerator
Handle Activated Fail Switch: This allows the device to turn off when the door is open, regardless if the device needs to run, and then start up again when it closes. This ensures the safety of the owner of the refrigerator
Power Connection System: This array essentially does two things, firstly, it provides electricity to the piezoelectric crystal, and secondly it connects to an outlet power source. It can be made of any power connection circuit available on the market.
Ultrasound—Soundproof Insulation: The device needs to be put into a soundproof encapsulation shell, using any material found in the market that blocks ultrasound.
Computer: This allows for the device to be turned off and on at will at a given distance. Can be preprogrammed to turn off and on at a select time frame. It can be made of any computer on the market.
System Of Function: Firstly, the Power Connection System powers the entire circuit. Secondly, the main power distribution goes into the Ultrasound

Distributor, followed by the Door Activated Fail Switch, which is found on the door of the refrigerator. The Switch can be found at the base of the circuit, between the Power Connection System and the Ultrasound Distributor. The Ultrasound—Soundproof Insulation encapsulates the circuit, being placed as a refrigerator shell that keeps in ultrasound.

### CONCLUSION

The disclosed embodiments are illustrative, not restrictive. While specific configurations of the [technology] have been described, it is understood that the present invention can be applied to a wide variety of [technology category]. There are many alternative ways of implementing the invention.

What is claimed is:

1. The refrigerator or storage system, wherein the ultrasonic wave generated by the ultrasonic wave generator propagates to an object to be preserved from the distribution of ultrasonic waves
a. The general use of (timed) ultrasonic waves to destroy microbes in food, the form of energy, is nonspecific, as all forms of energy (such as a burst) propagate this claim.

2. The use of ultrasonic waves controlled by a computerized system, in a storage device or refrigeration object.

3. The encapsulation of ultrasound waves in a storage device or refrigeration object.
